(19) United States
(12) Patent Application Publication
(10) Pub. No.: US 2024/0319759 A1
(43) Pub. Date: Sep. 26, 2024

(54) ARBITRARY WAVEFORM GENERATION APPARATUS AND ARBITRARY WAVEFORM GENERATION METHOD

(71) Applicant: ANRITSU CORPORATION, Kanagawa (JP)

(72) Inventors: Yasuo HOSAKA, Kanagawa (JP); Hiroyuki ONUMA, Kanagawa (JP)

(21) Appl. No.: 18/416,328

(22) Filed: Jan. 18, 2024

(30) Foreign Application Priority Data
Mar. 20, 2023 (JP) 2023-044446

(51) Int. Cl. G06F 1/02; G06F 1/03; G06F 7/58

(52) U.S. Cl. CPC G06F 1/022; G06F 1/0321; G06F 7/582

(57) ABSTRACT

There are provided a waveform memory that stores waveform data of an arbitrary waveform, a control unit that outputs the waveform data stored in the waveform memory in time-series order at predetermined time intervals, a waveform signal generation unit that generates a waveform signal by D/A converting the output waveform data, and a data processing unit that sequentially calculates waveform data in time-series order based on pulse pattern data, in which the control unit outputs the sequentially calculated waveform data from the data processing unit to the waveform signal generation unit at predetermined time intervals, and causes the waveform signal generation unit to generate a waveform signal by D/A conversion. The control unit includes a data working unit that executes data working processing on designated pulse pattern data, and generates worked waveform data having a capacity, which is storable in the waveform memory, at a data preparation stage.

### TECHNICAL FIELD

The present invention relates to an arbitrary waveform generation apparatus and an arbitrary waveform generation method.

### BACKGROUND ART

In the related art, performance of a device under test is evaluated by inputting a known test signal to the device under test and measuring an output signal from the device under test. As a device for generating the test signal, an arbitrary waveform generation apparatus that can generate an arbitrary waveform signal is used (see, for example, Patent Document 1).

FIG. 11 is a diagram illustrating a schematic configuration of an arbitrary waveform generation apparatus in the related art, disclosed in Patent Document 1. As illustrated in FIG. 11, an arbitrary waveform generation apparatus 100 in the related art includes a waveform memory 110 that stores waveform data 111, a waveform signal generation unit 120 that includes a digital-analog converter, and a control unit 130 that controls reading of the waveform data from the waveform memory 110. The arbitrary waveform generation apparatus 100 sequentially reads the waveform data 111 from the waveform memory 110 under the control of the control unit 130, and converts the digital waveform data into an analog signal by the digital-analog converter of the waveform signal generation unit 120 to output an arbitrary waveform signal.

### RELATED ART DOCUMENT

### Patent Document

[Patent Document 1] JP-B-H8-7643

### DISCLOSURE OF THE INVENTION

### Problem that the Invention is to Solve

Meanwhile, in the arbitrary waveform generation apparatus described in Patent Document 1, all waveform data is stored in the waveform memory in advance, in a case where a pseudo random signal consisting of a very long data string such as pseudo random bit sequence (PRBS) 31 is output, there is a problem in that a huge capacity of the waveform memory is required. In addition, in a case of outputting a digital signal using a non return to zero (NRZ) method, a plurality of bits are required to specify a resolution of the digital-analog converter for one bit representing high/low (H/L). Meanwhile, there is a problem in that the waveform memory larger than necessary is required.

In addition, the arbitrary waveform generation apparatus described in Patent Document 1 has a problem in that it is not possible to work the waveform data such as replacing a part of a pulse pattern waveform with another one, or applying a unique filter to the pulse pattern waveform to change a frequency characteristic at a data preparation stage.

The present invention is made to solve such problems, and an object of the present invention is to provide an arbitrary waveform generation apparatus and an arbitrary waveform generation method capable of generating a pulse pattern waveform without requiring a large-capacity waveform memory, in which pulse pattern data or waveform data obtained from the pulse pattern data can be worked at a data preparation stage.

### Means for Solving the Problem

According to the present invention, there is provided an arbitrary waveform generation apparatus including: a waveform memory (10) that stores waveform data, which is time-series data of an arbitrary waveform; a control unit (30) that performs control of outputting the waveform data stored in the waveform memory in time-series order at predetermined time intervals; a waveform signal generation unit (20) that generates a waveform signal by digital-analog converting the waveform data output under the control of the control unit; and a data processing unit (40) that sequentially calculates the waveform data in time-series order based on pulse pattern data, which is time-series data of a pulse pattern, when generating a pulse pattern waveform, in which the control unit outputs the sequentially calculated waveform data from the data processing unit to the waveform signal generation unit at the predetermined time intervals, and causes the waveform signal generation unit to generate a waveform signal by digital-analog conversion, and the control unit includes a data working unit (33) that executes data working processing on designated pulse pattern data to generate the waveform data having a capacity, which is storable in the waveform memory, at a data preparation stage.

As described above, the arbitrary waveform generation apparatus according to the present invention includes the data processing unit that sequentially calculates waveform data in time-series order based on pulse pattern data, that is time-series data of a pulse pattern, when generating a pulse pattern waveform, and the control unit outputs the sequentially calculated waveform data from the data processing unit to the waveform signal generation unit at the predetermined time intervals, and causes the waveform signal generation unit to generate a waveform signal by digital-analog conversion. With this configuration, there is no need to store all the data in the waveform memory in advance, and it is possible to generate even a waveform signal with a long pulse pattern such as a pseudo random signal or an NRZ-type digital signal, without requiring a large-capacity waveform memory The control unit includes the data working unit that executes data working processing on designated pulse pattern data, and generates worked waveform data having a capacity, which is storable in the waveform memory, at a data preparation stage. With this configuration, it is possible to easily perform working on pulse pattern data.

Further, in the arbitrary waveform generation apparatus according to the present invention, the data working unit may replace at least part of the designated pulse pattern data with other pulse pattern data having a designated length, and may cause the data processing unit to generate the waveform data having the capacity, which is storable in the waveform memory, based on the pulse pattern data after the replacement, at the data preparation stage.

With this configuration, the arbitrary waveform generation apparatus according to the present invention can easily perform data working in which at least part of pulse pattern data is replaced with other pulse pattern data.

Further, in the arbitrary waveform generation apparatus according to the present invention, the data working unit may execute processing of applying a designated filter to the waveform data calculated by the data processing unit based on the designated pulse pattern data to generate the waveform data having the capacity, which is storable in the waveform memory, at the data preparation stage.

With this configuration, the arbitrary waveform generation apparatus according to the present invention can easily perform data working to change a frequency characteristic of the waveform signal generated based on the pulse pattern data.

Further, in the arbitrary waveform generation apparatus according to the present invention, the data processing unit may include a pseudo random signal generation unit (42) that sequentially calculates the pulse pattern data based on a generation polynomial corresponding to a designated pseudo random bit sequence, and sequentially calculates the waveform data based on the sequentially calculated pulse pattern data, and the data working unit may generate the waveform data having the capacity, which is storable in the waveform memory, by performing the data working processing on the waveform data sequentially calculated by the pseudo random signal generation unit, at the data preparation stage.

With this configuration, the arbitrary waveform generation apparatus according to the present invention can generate even a signal with a long pulse pattern, such as a pseudo random signal, without requiring a large-capacity waveform memory. In addition, since the waveform data can be generated by performing the data working processing on the waveform data sequentially calculated by the pseudo random signal generation unit, the waveform signal can be generated at a waveform generation stage, without sequentially calculating the pseudo random signal.

Further, in the arbitrary waveform generation apparatus according to the present invention, the data processing unit may include an encoding processing unit (41) that sequentially calculates pulse pattern encoding data by encoding the pulse pattern data stored in the waveform memory by using a designated encoding method, and sequentially calculates the waveform data based on the sequentially calculated pulse pattern encoding data, and the data working unit may generate the waveform data having the capacity, which is storable in the waveform memory, by performing the data working processing on the waveform data sequentially calculated by the encoding processing unit, at the data preparation stage.

With this configuration, the arbitrary waveform generation apparatus according to the present invention can generate even a signal with a long pulse pattern, such as a pseudo random signal, without requiring a large-capacity waveform memory. In addition, since the waveform data can be generated by performing the data working processing on the waveform data sequentially calculated by the encoding processing unit, it is possible to generate the waveform signal at the waveform generation stage, without sequentially calculating the pulse pattern encoding data.

Further, in the arbitrary waveform generation apparatus according to the present invention, the data processing unit may include a pseudo random signal generation unit (42) that sequentially calculates the pulse pattern data based on a generation polynomial corresponding to a designated pseudo random bit sequence, and an encoding processing unit (41) that sequentially calculates pulse pattern encoding data by encoding the pulse pattern data sequentially calculated by the pseudo random signal generation unit by using a designated encoding method, and sequentially calculates the waveform data based on the sequentially calculated pulse pattern encoding data, and the data working unit may generate the waveform data having the capacity, which is storable in the waveform memory, by performing the data working processing on the waveform data sequentially calculated by the encoding processing unit, at the data preparation stage.

With this configuration, the arbitrary waveform generation apparatus according to the present invention can generate even a signal with a long pulse pattern, such as a pseudo random signal, without requiring a large-capacity waveform memory. In addition, since the waveform data can be generated by performing the data working processing on the waveform data sequentially calculated by the encoding processing unit, it is possible to generate the waveform signal at the waveform generation stage, without sequentially calculating the pulse pattern encoding data.

Further, according to the present invention, there is provided an arbitrary waveform generation method including: a step of storing waveform data, which is time-series data of an arbitrary waveform, in a waveform memory; a control step of performing control of outputting the waveform data stored in the waveform memory to a digital-analog converter at predetermined time intervals in time-series order; a waveform signal generation step of generating a waveform signal by digital-analog converting the waveform data output under the control in the control step, by the digital-analog converter; a data processing step of sequentially calculating the waveform data in time-series order based on pulse pattern data, which is time-series data of a pulse pattern, when generating a pulse pattern waveform; a step of performing control of outputting the sequentially calculated waveform data to the digital-analog converter at the predetermined time intervals and generating a waveform signal by digital-analog conversion; and a data working step of executing data working processing on the pulse pattern data to generate the waveform data having a capacity, which is storable in the waveform memory, at a data preparation stage.

As described above, the arbitrary waveform generation method of the present invention includes the data processing step of sequentially calculating, when generating a pulse pattern waveform, waveform data in time-series order based on pulse pattern data that is time-series data of a pulse pattern, step of performing control of outputting the sequentially calculated waveform data to the digital-analog converter at the predetermined time intervals and generating a waveform signal by digital-analog conversion. With this configuration, there is no need to store all the data in the waveform memory in advance, and it is possible to generate even a waveform signal with a long pulse pattern such as a pseudo random signal or an NRZ-type digital signal, without requiring a large-capacity waveform memory The data preparation stage also includes the data working step of executing the data working processing on the pulse pattern data to generate waveform data having a capacity, which is storable in the waveform memory. With this configuration, it is possible to easily perform working on pulse pattern data.

Further, in the arbitrary waveform generation method according to the present invention, in the data working step, at least part of the designated pulse pattern data may be replaced with other pulse pattern data having a designated length, and in the data processing step, the waveform data having the capacity, which is storable in the waveform memory, may be generated based on the pulse pattern data after the replacement, at the data preparation stage.

Further, in the arbitrary waveform generation method according to the present invention, in the data working step, processing of applying a designated filter to the waveform data calculated in the data processing step may be executed based on the designated pulse pattern data, and the waveform data having the capacity, which is storable in the waveform memory, may be generated at the data preparation stage.

Further, in the arbitrary waveform generation method according to the present invention, in the data processing step, the pulse pattern data may be sequentially calculated based on a generation polynomial corresponding to a designated pseudo random bit sequence, and the waveform data may be sequentially calculated based on the sequentially calculated pulse pattern data to generate a pseudo random signal, and in the data working step, the waveform data having the capacity, which is storable in the waveform memory, may be generated by performing the data working processing on the waveform data sequentially calculated in the generating of the pseudo random signal, at the data preparation stage.

Further, in the arbitrary waveform generation method according to the present invention, in the data processing step, pulse pattern encoding data may be sequentially calculated by encoding the pulse pattern data stored in the waveform memory by using a designated encoding method, and the waveform data may be sequentially calculated based on the sequentially calculated pulse pattern encoding data to perform encoding processing, and in the data working step, the waveform data having the capacity, which is storable in the waveform memory, may be generated by performing the data working processing on the waveform data sequentially calculated by the encoding processing, at the data preparation stage.

Further, in the arbitrary waveform generation method according to the present invention, in the data processing step, the pulse pattern data may be sequentially calculated based on a generation polynomial corresponding to a designated pseudo random bit sequence to generate a pseudo random signal, and pulse pattern encoding data may be sequentially calculated by encoding the pulse pattern data sequentially calculated in the generating of the pseudo random signal by using a designated encoding method, and the waveform data is sequentially calculated based on the sequentially calculated pulse pattern encoding data to perform encoding processing, and in the data working step, the waveform data having the capacity, which is storable in the waveform memory, may be generated by performing the data working processing on the waveform data sequentially calculated by the encoding processing, at the data preparation stage.

### Advantage of the Invention

According to the present invention, there is provided an arbitrary waveform generation apparatus and an arbitrary waveform generation method capable of generating a pulse pattern waveform without requiring a large-capacity waveform memory, in which pulse pattern data or waveform data obtained from the pulse pattern data can be worked at a data preparation stage.

### BRIEF DESCRIPTION OF THE DRAWINGS

FIG. 1 is a diagram illustrating a schematic configuration of an arbitrary waveform generation apparatus according to an embodiment of the present invention.

FIG. 2 is a diagram illustrating example of a display screen of a display unit.

FIG. 3 is a diagram illustrating another example of the display screen of the display unit.

FIG. 4 is a diagram illustrating still another example of the display screen of the display unit.

FIG. 5 is a diagram illustrating still another example of the display screen of the display unit.

FIG. 6 is a diagram illustrating a flowchart of the arbitrary waveform generation method according to the embodiment of the present invention.

FIG. 7 is a diagram illustrating an example of a display screen of the display unit during data working processing.

FIG. 8 is a diagram illustrating another example of the display screen of the display unit during the data working processing.

FIG. 9 is a diagram illustrating still another example of the display screen of the display unit during the data working processing.

FIG. 10 is a diagram illustrating a flowchart of the data working processing according to the embodiment of the present invention.

FIG. 11 is a diagram illustrating a schematic configuration of an arbitrary waveform generation apparatus in the related art.

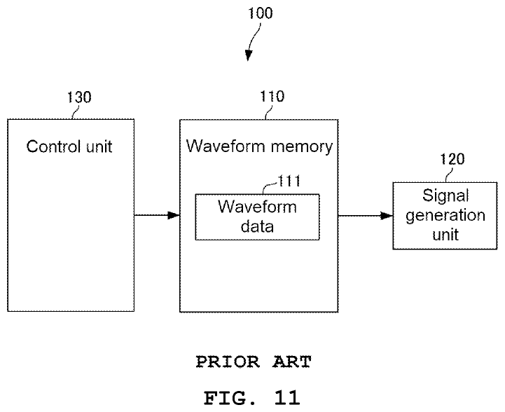

### BEST MODE FOR CARRYING OUT THE INVENTION

Hereinafter, embodiments of the present invention will be described with reference to the drawings.

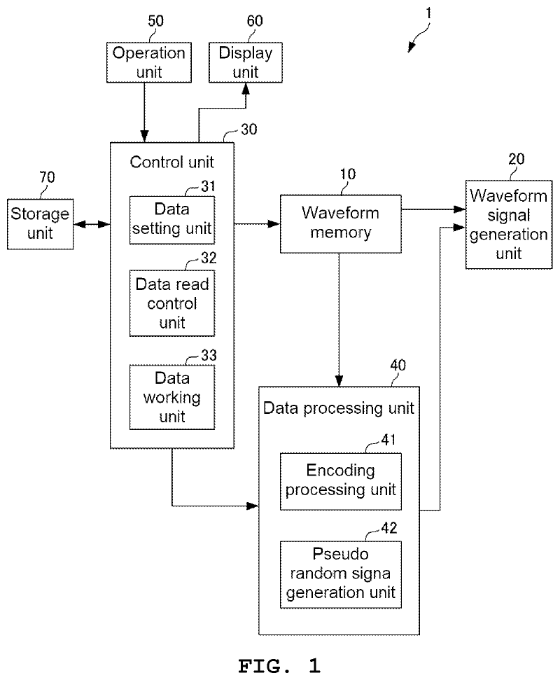

FIG. 1 is a diagram illustrating a schematic configuration of an arbitrary waveform generation apparatus 1 according to the present embodiment. As illustrated in FIG. 1, the arbitrary waveform generation apparatus 1 includes a waveform memory 10, a waveform signal generation unit 20, a control unit 30, a data processing unit 40, an operation unit 50, a display unit 60, and a storage unit 70.

### (Waveform Memory)

The waveform memory 10 stores “waveform data” which is time-series data of an arbitrary waveform. Further, in a case where a waveform of a pulse pattern set by a user is generated, the waveform memory 10 stores “pulse pattern data” which is time-series data of the pulse pattern.

The waveform data includes, for example, data strings f(t1), f(t2), . . . , and f (tN) of values of a waveform f(t) at times t1, t2, . . . , and tN. In this case, the waveform memory 10 stores the waveform data f(t1), f(t2), . . . , and f (tN) at predetermined addresses. Each piece of data in the data strings constituting the waveform data is sequentially read and provided to the waveform signal generation unit 20 to generate a waveform signal. That is, the waveform data is a data string with which the waveform signal generation unit 20 can generate a desired waveform signal.

The pulse pattern data includes, for example, pulse patterns B1, B2, . . . , Bm, . . . , and BM (where Bm is 0 or 1). The pulse pattern data includes pulse pattern data based on a pulse pattern set by the user and pulse pattern data generated from a PRBS designated by the user. In a case of the pulse pattern data based on the pulse pattern set by the user, the pulse pattern data B1, B2, . . . , and BM are stored in the waveform memory 10. In either case, the pulse pattern data B1, B2, . . . , and BM are sequentially generated or acquired, subjected to encoding processing designated by the user if necessary, and are sequentially converted into waveform data usable by the waveform signal generation unit 20.

### (Waveform Signal Generation Unit)

The waveform signal generation unit 20 includes a digital-analog converter (also referred to as a D/A converter), and generates a waveform signal by performing digital-analog conversion on the waveform data output under output control of the control unit 30.

### (Control Unit)

The control unit 30 includes a data setting unit 31, a data read control unit 32, and a data working unit 33.

The data setting unit 31 acquires waveform data or pulse pattern data stored in the storage unit 70 based on setting information (waveform, encoding method, PRBS, signal level, and the like) input by the user via the operation unit 50, and sets the waveform data or the pulse pattern data in the waveform memory 10. In addition, based on setting information on an encoding method input by the user via the operation unit 50, the data setting unit 31 sets the encoding method for causing the encoding the processing unit 41 to execute encoding using designated encoding method. Further, based on information specifying a pseudo random signal input by the user via the operation unit 50, the data setting unit 31 sets the pseudo random signal for causing the pseudo random signal generation unit 42 to use a generation polynomial corresponding to the pseudo random signal.

The data read control unit 32 performs output control to output the waveform data stored in the waveform memory 10 to the waveform signal generation unit 20 in time-series order at predetermined time intervals. The output waveform data is converted into an analog waveform signal by the waveform signal generation unit 20.

Further, when generating a pulse pattern waveform in a case where pulse pattern data is stored in the waveform memory 10, the data read control unit 32 performs output control for outputting the pulse pattern data stored in the waveform memory 10 to the data processing unit 40 in time-series order.

In addition, in a case of generating a pulse pattern waveform, the data read control unit 32 outputs waveform data sequentially calculated by the data processing unit 40 from the data processing unit 40 to the waveform signal generation unit 20 at predetermined time intervals, and causes the waveform signal generation unit 20 to generate a waveform signal by performing digital-analog conversion.

The data working unit 33 performs data working processing on the designated pulse pattern data, and generates worked waveform data having a capacity that can be stored in the waveform memory 10, at a data preparation stage. The worked waveform data is stored in the storage unit 70, for example.

The control unit 30 is configured with, for example, a computer having a central processing unit (CPU), a storage device such as a read only memory (ROM), a random access memory (RAM), a hard disk drive (HDD), a solid state drive (SDD), and the like. The control unit 30 may be configured to control an operation of each unit constituting the arbitrary waveform generation apparatus 1. The control unit 30 can perform the control by reading a control program stored in the ROM or the storage device into the RAM and executing the control program by the CPU.

### (Data Processing Unit)

The data processing unit 40 performs necessary data processing (encoding, signal level adjustment, or the like) based on pulse pattern data, which is time-series data of a pulse pattern, and sequentially calculates waveform data in time-series order. Therefore, the data processing unit 40 includes an encoding processing unit 41 and a pseudo random signal generation unit 42.

The pseudo random signal generation unit 42 sequentially calculates pulse pattern data (pseudo random bit sequence) based on a generation polynomial corresponding to a designated pseudo random bit sequence, and sequentially calculates waveform data based on the sequentially calculated pseudo random bit sequence.

The encoding processing unit 41 encodes the pulse pattern data output from the waveform memory 10 under output control by the control unit 30 by using a designated encoding method and sequentially calculates pulse pattern encoding data, and sequentially calculates waveform data based on the sequentially calculated pulse pattern encoding data.

The encoding processing unit 41 may sequentially calculate waveform data in time-series order based on the pulse pattern data output from the waveform memory 10 under the output control of the control unit 30.

The data processing unit 40 may cause the pseudo random signal generation unit 42 to generate pulse pattern data (pseudo random bit sequence) based on the generation polynomial corresponding to the designated pseudo random bit sequence, cause the encoding processing unit 41 to encode the pulse pattern data by using a designated encoding method and to sequentially calculate pulse pattern encoding data, and sequentially calculate waveform data based on the sequentially calculated pulse pattern encoding data.

### <Generation of Pseudo Random Signal>

The pseudo random signal generation unit 42 is configured with n shift registers connected in series, and an exclusive OR gate in which an exclusive OR of an output signal of a shift register at a final stage and an output signal of one or more intermediate shift registers determined by the number n of stages of the shift register is returned as a feedback signal to a shift register at a head. A period (pattern length) of the generated pseudo random signal is 2ⁿ−1. For example, in a case where the pseudo random signal is PRBS31, a generation polynomial is 1+X²⁸+X³¹, and a period is 2³¹−1=2, 147, 483, 647 bits.

### <Encoding>

The encoding method performed by the encoding processing unit 41 is, for example, an NRZ modulation method in which zero is not returned among each bit, a pulse amplitude modulation (PAM) method which is a method in which an amplitude is divided into four or more levels for each symbol, a quadrature amplitude modulation (QAM) method, which is a modulation method in which data is transmitted by changing and adjusting amplitudes of two mutually independent carrier waves, or the like. As a transmission method for handling PAM signals, for example, a PAM4 method for transmitting PAM4 signals, a PAM8 method for transmitting PAM8 signals, and the like are known. Among these, the PAM4 method is a method of using a pulse amplitude modulation (PAM) signal obtained by encoding an amplitude of an information signal with a series of pulse signals, and modulating and transmitting a bit string configured with logics “0” and “1” as a pulse signal of four voltage levels or optical power. For example, 16QAM is a method by which 16 values (4-bit data) can be transmitted at one time, among QAMs that are modulation methods for digital signals.

The data processing unit 40 can be configured with a digital circuit such as a field programmable gate array (FPGA) or an application specific integrated circuit (ASIC). Alternatively, depending on a processing speed, at least a part of the data processing unit 40 can be configured by appropriately combining hardware processing by a digital circuit and software processing by a predetermined program.

### (Operation Unit)

The operation unit 50 is to accept an operation input of a user, and is configured with, for example, a touch panel that is provided at the display unit 60. Alternatively, the operation unit 50 may include an input device such as a keyboard or a mouse. In addition, the operation unit 50 may be configured with an external control apparatus which performs remote control by using a remote command or the like. The operation input to the operation unit 50 is detected by the control unit 30. For example, the user can use the operation unit 50 to set setting information on a waveform to be generated, an encoding method, a pseudo random signal, a signal level, and the like.

### (Display Unit)

The display unit 60 is configured with, for example, a display device such as an LCD or a CRT, and performs a display on an operation target such as a button, a soft key, a pull-down menu, and a text box for setting various conditions for waveform signal generation according to the control signal output from the control unit 30.

### <Data Working Unit>

Next, the data working unit 33 will be described.

The data working unit 33 provided in the control unit 30 performs data working processing designated by the user on pulse pattern data designated by the user, and generates worked waveform data having a capacity that can be stored in the waveform memory 10, at a data preparation stage. The worked waveform data on which the data working processing is executed by the data working unit 33 is stored in the storage unit 70, for example. At a waveform generation stage, the worked waveform data is read from the storage unit 70, set in the waveform memory 10, and is sequentially read from the waveform memory 10 to generate a waveform signal by the waveform signal generation unit 20.

Specifically, at the data preparation stage, the data working unit 33 replaces at least part of the pulse pattern data designated by the user with other pulse pattern data having a designated length designated by the user, and the data processing unit 40 generates worked waveform data having a capacity, which can be stored in the waveform memory 10, based on the pulse pattern data after the replacement.

Further, at the data preparation stage, the data working unit 33 executes processing of applying a filter designated by the user to the waveform data calculated by the data processing unit 40 based on the pulse pattern data designated by the user, so that the worked waveform data having a capacity, which can be stored in the waveform memory 10, is generated. The filter to be used for the processing is, for example, a low-pass filter or a finite impulse response (FIR) filter.

Further, the data working unit 33 generates the worked waveform data having a capacity, which can be stored in the waveform memory 10, by performing the data working processing on the waveform data sequentially calculated by the pseudo random signal generation unit 42, at the data preparation stage. Specifically, at the data preparation stage, the data working unit 33 causes the pseudo random signal generation unit 42 to sequentially calculate pulse pattern data (pseudo random bit sequence) based on a generation polynomial corresponding to a pseudo random bit sequence designated by the user, and sequentially calculate waveform data based on the calculated pseudo random bit sequence.

Further, the data working unit 33 generates the worked waveform data having a capacity, which can be stored in the waveform memory 10, by performing the data working processing on the waveform data sequentially calculated by the encoding processing unit 41, at the data preparation stage. Specifically, at the data preparation stage, the data working unit 33 causes the encoding processing unit 41 to encode the pulse pattern data stored in the waveform memory 10 by using an encoding method designated by the user and sequentially calculate pulse pattern encoding data, and sequentially calculate waveform data based on the calculated pulse pattern encoding data.

In addition, at the data preparation stage, the data working unit 33 may cause the pseudo random signal generation unit 42 to sequentially calculate pulse pattern data (pseudo random bit sequence) based on the generation polynomial corresponding to the pseudo random bit sequence designated by the user, and cause the encoding processing unit 41 to encodes the calculated pseudo random bit sequence by using the encoding method designated by the user and sequentially calculate pulse pattern encoding data, and sequentially calculate waveform data based on the calculated pulse pattern encoding data.

In the above description, the encoding processing unit 41 or the pseudo random signal generation unit 42 is used in the data working processing by the data working unit 33. Meanwhile, the embodiment is not limited thereto, and the data working unit 33 may have the function of the encoding processing unit 41 or the pseudo random signal generation unit 42.

### <Arbitrary Waveform Generation Method>

Next, an arbitrary waveform generation method will be described.

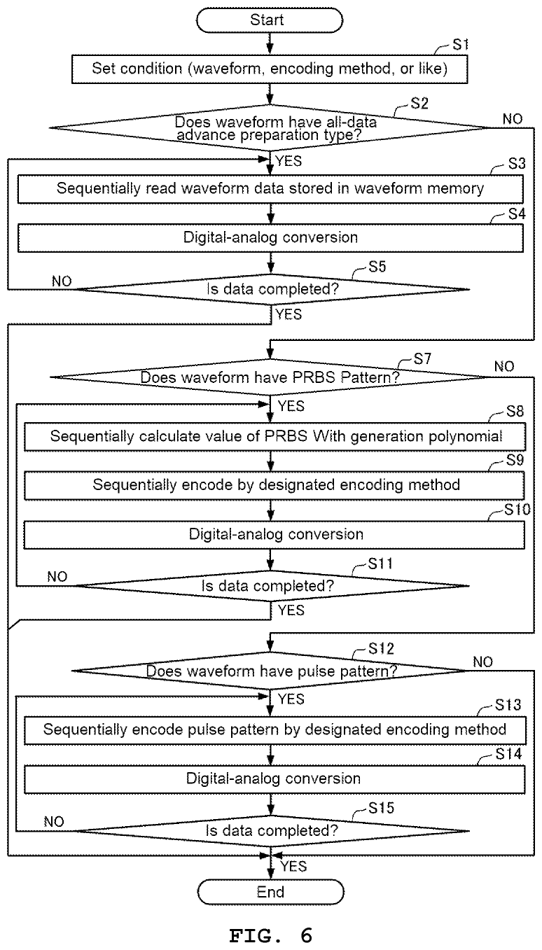

FIG. 6 is a diagram illustrating a flowchart of an arbitrary waveform generation method according to the embodiment of the present invention.

As illustrated in FIG. 6, first, a user operates, for example, the operation unit 50 to set a condition such as a waveform, an encoding method, a pseudo random signal, and a signal level (step S1). The control unit 30 determines whether or not the waveform set by the user is an arbitrary waveform generator type waveform (that is, an all-data advance preparation type in which all data is prepared in advance) (S2), and in a case where the determination is negative (NO in step S2), the process proceeds to step S7. In a case where the determination is positive (YES in step S2), the data setting unit 31 of the control unit 30 stores the designated waveform data in the waveform memory 10. Next, the data read control unit 32 of the control unit 30 sequentially reads waveform data stored in the waveform memory 10 at predetermined time intervals (step S3). The waveform signal generation unit 20 converts the waveform data read from the waveform memory 10 into an analog waveform signal by digital-analog conversion (step S4). The control unit 30 determines whether or not all the waveform data is read (S5), and in a case where the determination is negative (NO in S5), the process is returned to step S3 and continued. In a case where the determination is positive (YES in S5), the process is ended.

In step S7, the control unit 30 determines whether or not the waveform set by the user has a PRBS pattern (S7), and in a case where the determination is negative (NO in step S7), the process proceeds to step S12. In a case where the determination is positive (YES in step S7), the data processing unit 40 sequentially calculates a value of a PRBS by using a generation polynomial corresponding to the designated PRBS (step S8). The data processing unit 40 sequentially encodes the sequentially calculated PRBS value by using a designated encoding method, and converts the resultant value into waveform data (step S9). The waveform signal generation unit 20 converts the waveform data corresponding to the PRBS values sequentially encoded by the data processing unit 40 into an analog signal waveform by digital-analog conversion (step S10). The control unit 30 determines whether or not all data of the PRBS pattern is completed (S11), and in a case where the determination is negative (NO in S11), the process is returned to step S8 and continued. In a case where the determination is positive (YES in S11), the process is ended.

In step S12, the control unit 30 determines whether or not the waveform set by the user has a pulse pattern (S12), and in a case where the determination is negative (NO in step S12), the process is ended. In a case where the determination is positive (YES in step S12), the data processing unit 40 acquires pulse pattern data stored in the waveform memory 10, and sequentially encodes the pulse pattern data by using the designated encoding method (step S13). The waveform signal generation unit 20 converts a value of the pulse pattern sequentially encoded by the data processing unit 40 into an analog waveform signal by digital-analog conversion (step S14). The control unit 30 determines whether or not all the data of the pulse pattern is completed (S15), and in a case where the determination is negative (NO in S15), the process is returned to step S13 and continued. In a case where the determination is positive (YES in S15), the process is ended.

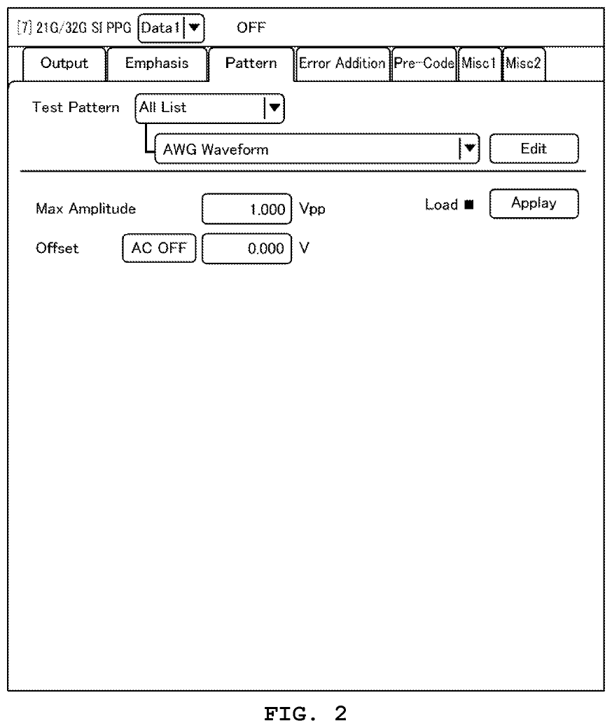

FIG. 2 illustrates an example of a screen in a case where an arbitrary waveform is output. If “AWG Waveform” is selected in an item of “Test Pattern”, a waveform file can be selected, and waveform data included in the waveform file is stored in the waveform memory 10, and the waveform signal generation unit 20 can output a waveform signal. In FIG. 2, “Max Amplitude” and “Offset” can be set.

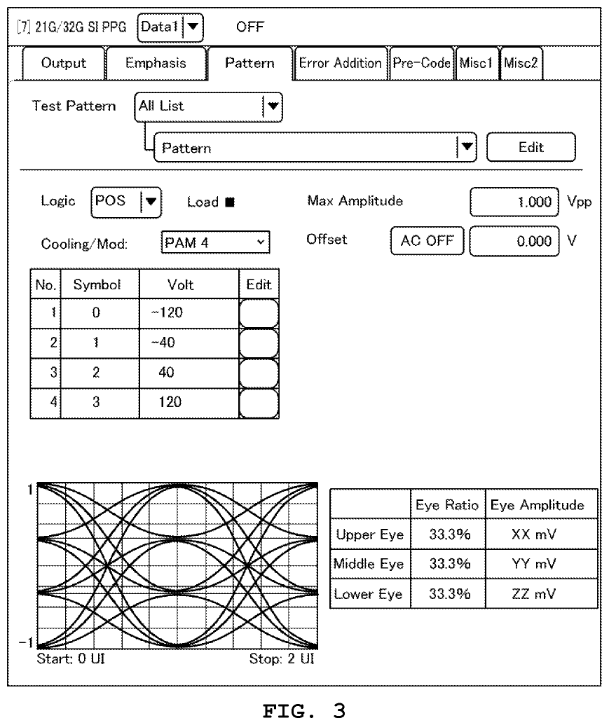

FIG. 3 illustrates an example of a screen in a case where a waveform signal is output based on pulse pattern data stored in the waveform memory 10. If “Pattern” is selected in an item of “Test Pattern”, a pulse pattern data file can be selected, and an encoding method or an amplitude level can be set. In FIG. 3, PAM4 is selected as the encoding method. By editing “Symbol” and “Volt” in encoding, “Eye Ratio” and “Eye Amplitude” in an eye diagram can also be set.

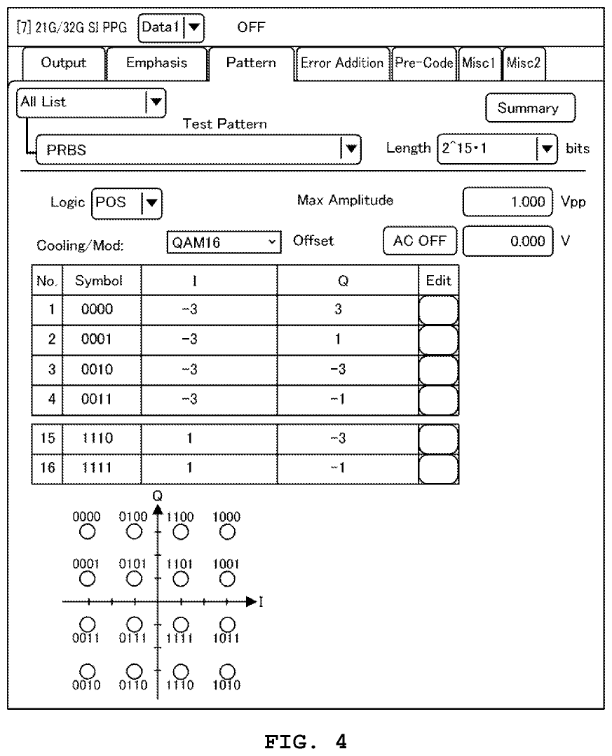

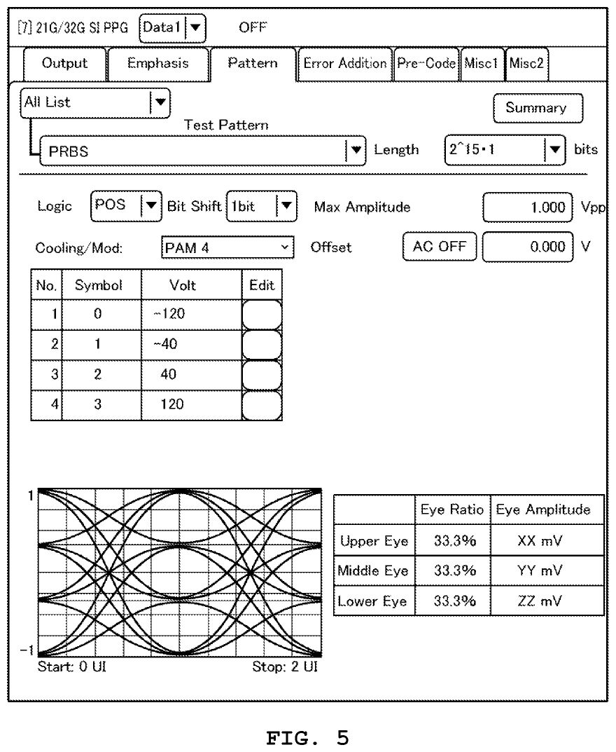

FIGS. 4 and 5 illustrate examples of screens in a case where a PRBS pattern is output. If “PRBS” is selected in an item of “Test Pattern”, a type, an encoding method, and an amplitude level of the PRBS can be set. In FIG. 4, QAM16 is selected as the encoding method, and in FIG. 5, PAM4 is selected as the encoding method.

### <Data Working Method>

Next, a data working method at a data preparation stage will be described.

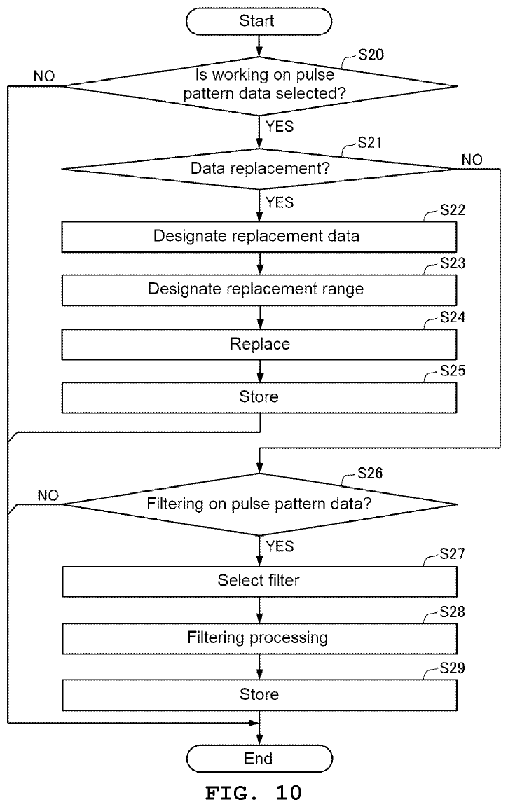

FIG. 10 is a flowchart of a data working method according to the present embodiment.

The control unit 30 determines whether or not working on pulse pattern data is selected by a user (step S20). If the determination result is negative (NO in step S20), the process is ended. If the determination result is positive (YES in step S20), the process proceeds to step S21.

In step S21, the control unit 30 determines whether or not a content of the data working processing is replacement of part of the pulse pattern data. If the determination result is negative (NO in step S21), the process proceeds to step S26. If the determination result is positive (YES in step S21), a pulse pattern data file as a data working target is selected, and new pulse pattern data to be replaced is designated (or set) via the operation unit 50, for example (step S22).

Next, the user designates, for example, via the operation unit 50, which range of data is to be replaced among the pulse pattern data as a data working target (step S23). The data working unit 33 replaces the data in the designated replacement range among the pulse pattern data as a data working target with the set new data (step S24).

Next, the data processing unit 40 calculates waveform data based on the replaced pulse pattern data, and stores the waveform data in the storage unit 70 as worked waveform data having a capacity, which can be stored in the waveform memory 10 (step S25).

In step S26, based on a user input via the operation unit 50, it is determined whether or not to apply a filter to the pulse pattern data designated by the user. If the determination result is negative (NO in step S26), the process is ended. If the determination result is positive (YES in step S26), for example, a filter is selected (or set) via the operation unit 50 (step S27), and the data working unit 33 executes filtering processing on the waveform data calculated by the data processing unit 40 by using the selected filter based on the pulse pattern data designated by the user (step S28). The data working unit 33 stores the worked waveform data having a capacity, which can be stored in the waveform memory 10, in the storage unit 70 (step S29). The filtering may be performed by the data processing unit 40.

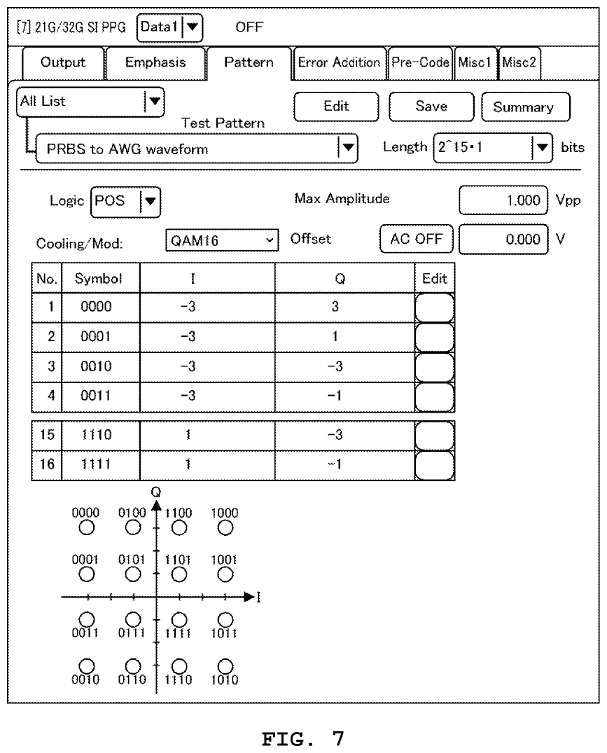

FIG. 7 is a diagram illustrating an example of a display screen of the display unit 60 during data working processing. FIG. 7 illustrates an example of a screen for data working on a PRBS into an AWG waveform (waveform data). When “PRBS to AWG Waveform” is selected in an item of “Test Pattern”, a PRBS on which data working is to be performed can be selected, and an encoding method, a signal level, and the like can be set. In FIG. 7, PRBS15 in which a period (pattern length) of a pseudo random signal is 215-1 bits is selected, and QAM16 is selected as the encoding method. “Max Amplitude” is set to 1.000 Vpp, and a correspondence between “Symbol” and “I” and “Q” in encoding can be edited. When “Save” is selected, the worked waveform data obtained by encoding the PRBS and converting the PRBS into waveform data (AWG waveform) can be stored in the storage unit 70.

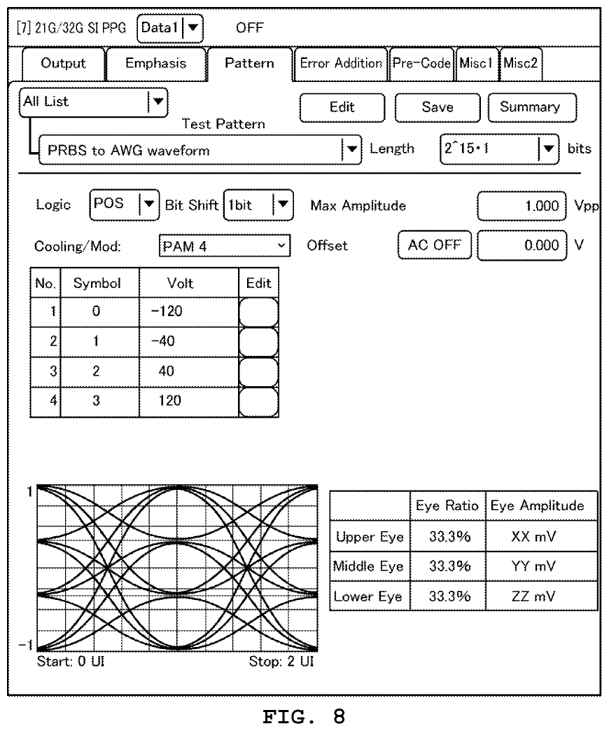

FIG. 8 illustrates another example of the screen for data working on a PRBS into an AWG waveform (waveform data). In FIG. 8, PAM4 is selected as the encoding method. By editing “Symbol” and “Volt” in encoding, “Eye Ratio” and “Eye Amplitude” in an eye diagram can also be set.

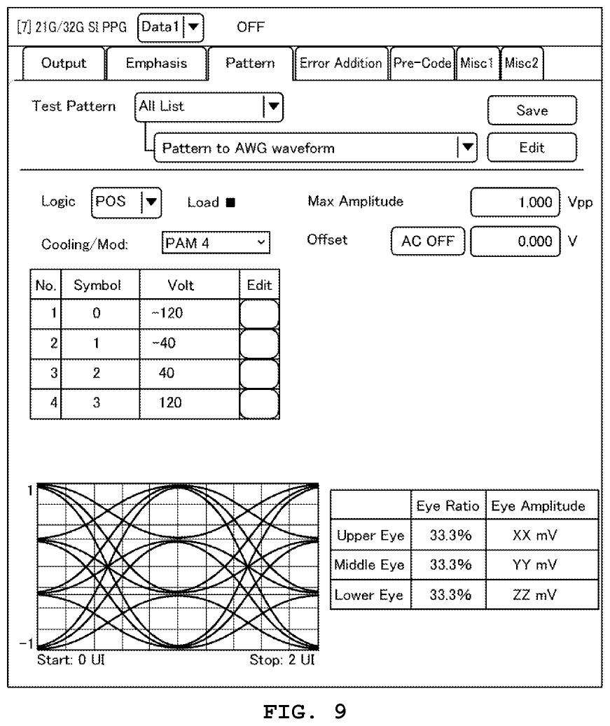

FIG. 9 illustrates an example of a screen for data working on pulse pattern data into an AWG waveform (waveform data). If “Pattern to AWG Waveform” is selected in an item of “Test Pattern”, for example, a pulse pattern data file as a data working target can be selected, and an encoding method, a signal level, and the like can be set. In FIG. 9, PAM4 is selected as the encoding method.

### <Action and Effect>

As described above, in the arbitrary waveform generation apparatus 1 according to the present embodiment, the control unit 30 includes the data working unit 33 that executes the data working processing on the pulse pattern data designated by the user, and generates worked waveform data having a capacity that can be stored in the waveform memory 10, at the data preparation stage. With this configuration, it is possible to easily perform working on waveform data of a pulse pattern.

In addition, in the arbitrary waveform generation apparatus 1 according to the present embodiment, at the data preparation stage, the data working unit 33 can replace at least part of the pulse pattern data designated by the user with other pulse pattern data having a designated length designated by the user, and the data processing unit 40 can generate worked waveform data having a capacity, which can be stored in the waveform memory 10, based on the pulse pattern data after the replacement. With this configuration, it is possible to easily perform data working in which at least part of the pulse pattern data is replaced with other pulse pattern data.

In addition, in the arbitrary waveform generation apparatus 1 according to the present embodiment, at the data preparation stage, the data working unit 33 can execute processing of applying a filter designated by the user to the waveform data calculated by the data processing unit 40 based on the pulse pattern data designated by the user, so that the worked waveform data having a capacity, which can be stored in the waveform memory 10, can be generated. With this configuration, it is possible to easily perform data working to change the frequency characteristic of the worked waveform data obtained from the pulse pattern data.

Further, in the arbitrary waveform generation apparatus 1 according to the present embodiment, the data working unit 33 can generate the worked waveform data having a capacity, which can be stored in the waveform memory 10, by performing the data working processing on the waveform data sequentially calculated by the pseudo random signal generation unit 42, at the data preparation stage. With this configuration, the worked waveform data by performing the data working processing on the waveform data sequentially calculated by the pseudo random signal generation unit 42 can be generated and stored in the storage unit 70, so that the waveform signal can be generated at the waveform generation stage, without sequentially calculating the pseudo random signal.

Further, in the arbitrary waveform generation apparatus 1 according to the present embodiment, at the data preparation stage, the data working unit 33 can generate the worked waveform data having a capacity, which can be stored in the waveform memory 10, by performing the data working processing on the waveform data sequentially calculated by the encoding processing unit 41. With this configuration, the worked waveform data by performing the data working processing on the waveform data sequentially calculated by the encoding processing unit 41 can be generated and stored in the storage unit 70, so that the waveform signal can be generated at the waveform generation stage, without sequentially calculating the pulse pattern encoding data.

Further, in the arbitrary waveform generation apparatus 1 according to the present embodiment, the encoding processing unit 41 can sequentially calculate pulse pattern encoding data by encoding the pulse pattern data (pseudo random bit sequence) sequentially calculated by the pseudo random signal generation unit 42 by using an encoding method designated by the user, and can sequentially calculate waveform data based on the calculated pulse pattern encoding data. The data working unit 33 can generate the worked waveform data having a capacity, which can be stored in the waveform memory 10, by performing the data working processing on the waveform data sequentially calculated by the encoding processing unit 41 at the data preparation stage. With this configuration, the worked waveform data by performing the data working processing on the waveform data sequentially calculated by the encoding processing unit 41 can be generated and stored in the storage unit 70, so that the waveform signal can be generated at the waveform generation stage, without sequentially calculating the pulse pattern encoding data.

### INDUSTRIAL APPLICABILITY

As described above, the present invention has the effect that even a signal with a long pulse pattern can be generated without requiring a large-capacity waveform memory and working can be performed on pulse pattern data or waveform data obtained from the pulse pattern data at a data preparation stage, and is useful for arbitrary waveform generation apparatus and arbitrary waveform generation method in general.

### DESCRIPTION OF REFERENCE NUMERALS AND SIGNS

1 Arbitrary waveform generation apparatus
10 Waveform memory
20 Waveform signal generation unit
30 Control unit
31 Data setting unit
32 Data read control unit
33 Data working unit
40 Data processing unit
41 Encoding processing unit
42 Pseudo random signal generation unit
50 Operation unit
60 Display unit
70 Storage unit

What is claimed is:

1. An arbitrary waveform generation apparatus comprising:
a waveform memory that stores waveform data, which is time-series data of an arbitrary waveform;
a control unit that performs control of outputting the waveform data stored in the waveform memory in time-series order at predetermined time intervals;
a waveform signal generation unit that generates a waveform signal by performing digital-analog conversion on the waveform data output under the control of the control unit; and
a data processing unit that sequentially calculates the waveform data in time-series order based on pulse pattern data, which is time-series data of a pulse pattern, when generating a pulse pattern waveform,
wherein the control unit outputs the sequentially calculated waveform data from the data processing unit to the waveform signal generation unit at the predetermined time intervals, and causes the waveform signal generation unit to generate a waveform signal by digital-analog conversion, and
the control unit includes a data working unit that executes data working processing on designated pulse pattern data to generate the waveform data having a capacity, which is storable in the waveform memory, at a data preparation stage.

2. The arbitrary waveform generation apparatus according to claim 1,
wherein the data working unit replaces at least part of the designated pulse pattern data with other pulse pattern data having a designated length, and causes the data processing unit to generate the waveform data having the capacity, which is storable in the waveform memory, based on the pulse pattern data after the replacement, at the data preparation stage.

3. The arbitrary waveform generation apparatus according to claim 1,
wherein the data working unit executes processing of applying a designated filter to the waveform data calculated by the data processing unit based on the designated pulse pattern data to generate the waveform data having the capacity, which is storable in the waveform memory, at the data preparation stage.

4. The arbitrary waveform generation apparatus according to claim 1,
wherein the data processing unit includes a pseudo random signal generation unit that sequentially calculates the pulse pattern data based on a generation polynomial corresponding to a designated pseudo random bit sequence, and sequentially calculates the waveform data based on the sequentially calculated pulse pattern data, and
the data working unit generates the waveform data having the capacity, which is storable in the waveform memory, by performing the data working processing on the waveform data sequentially calculated by the pseudo random signal generation unit, at the data preparation stage.

5. The arbitrary waveform generation apparatus according to claim 1,
wherein the data processing unit includes an encoding processing unit that sequentially calculates pulse pattern encoding data by encoding the pulse pattern data stored in the waveform memory by using a designated encoding method, and sequentially calculates the waveform data based on the sequentially calculated pulse pattern encoding data, and
the data working unit generates the waveform data having the capacity, which is storable in the waveform memory, by performing the data working processing on the waveform data sequentially calculated by the encoding processing unit, at the data preparation stage.

6. The arbitrary waveform generation apparatus according to claim 1,
wherein the data processing unit includes
a pseudo random signal generation unit that sequentially calculates the pulse pattern data based on a generation polynomial corresponding to a designated pseudo random bit sequence, and
an encoding processing unit that sequentially calculates pulse pattern encoding data by encoding the pulse pattern data sequentially calculated by the pseudo random signal generation unit by using a designated encoding method, and sequentially calculates the waveform data based on the sequentially calculated pulse pattern encoding data, and
the data working unit generates the waveform data having the capacity, which is storable in the waveform memory, by performing the data working processing on the waveform data sequentially calculated by the encoding processing unit, at the data preparation stage.

7. An arbitrary waveform generation method comprising:
a step of storing waveform data, which is time-series data of an arbitrary waveform, in a waveform memory;
a control step of performing control of outputting the waveform data stored in the waveform memory to a digital-analog converter at predetermined time intervals in time-series order;
a waveform signal generation step of generating a waveform signal by performing digital-analog conversion on the waveform data output under the control in the control step, by the digital-analog converter;
a data processing step of sequentially calculating the waveform data in time-series order based on pulse pattern data, which is time-series data of a pulse pattern, when generating a pulse pattern waveform;
a step of performing control of outputting the sequentially calculated waveform data to the digital-analog converter at the predetermined time intervals and generating a waveform signal by digital-analog conversion; and
a data working step of executing data working processing on the pulse pattern data to generate the waveform data having a capacity, which is storable in the waveform memory, at a data preparation stage.

8. The arbitrary waveform generation method according to claim 7,
wherein in the data working step, at least part of the designated pulse pattern data is replaced with other pulse pattern data having a designated length, and in the data processing step, the waveform data having the capacity, which is storable in the waveform memory, is generated based on the pulse pattern data after the replacement, at the data preparation stage.

9. The arbitrary waveform generation method according to claim 7,
wherein in the data working step, processing of applying a designated filter to the waveform data calculated in the data processing step is executed based on the designated pulse pattern data, and the waveform data having the capacity, which is storable in the waveform memory, is generated at the data preparation stage.

10. The arbitrary waveform generation method according to claim 7,
wherein in the data processing step, the pulse pattern data is sequentially calculated based on a generation polynomial corresponding to a designated pseudo random bit sequence, and the waveform data is sequentially calculated based on the sequentially calculated pulse pattern data to generate a pseudo random signal, and
in the data working step, the waveform data having the capacity, which is storable in the waveform memory, is generated by performing the data working processing on the waveform data sequentially calculated in the generating of the pseudo random signal, at the data preparation stage.

11. The arbitrary waveform generation method according to claim 7,
wherein in the data processing step, pulse pattern encoding data is sequentially calculated by encoding the pulse pattern data stored in the waveform memory by using a designated encoding method, and the waveform data is sequentially calculated based on the sequentially calculated pulse pattern encoding data to perform encoding processing, and
in the data working step, the waveform data having the capacity, which is storable in the waveform memory, is generated by performing the data working processing on the waveform data sequentially calculated by the encoding processing, at the data preparation stage.

12. The arbitrary waveform generation method according to claim 7,
wherein in the data processing step,
the pulse pattern data is sequentially calculated based on a generation polynomial corresponding to a designated pseudo random bit sequence to generate a pseudo random signal, and
pulse pattern encoding data is sequentially calculated by encoding the pulse pattern data sequentially calculated in the generating of the pseudo random signal by using a designated encoding method, and the waveform data is sequentially calculated based on the sequentially calculated pulse pattern encoding data to perform encoding processing, and
in the data working step, the waveform data having the capacity, which is storable in the waveform memory, is generated by performing the data working processing on the waveform data sequentially calculated by the encoding processing, at the data preparation stage.
